(19) United States
(12) Patent Application Publication
(10) Pub. No.: US 2012/0305466 A1
(43) Pub. Date: Dec. 6, 2012

(54) STRUCTURE FOR FILTERING WATER

(76) Inventor: YAO-TSUNG WU, New Taipei City (TW)

(21) Appl. No.: 13/118,491

(22) Filed: May 30, 2011

(51) Int. Cl. C02F 9/02

(52) U.S. Cl. 210/259

(57) ABSTRACT

A structure for filtering water comprises a housing, an inlet pipe, a dirty-water pipe, an outlet pipe, and a membrane assembly. The inlet pipe is connected to a first end of the housing. The dirty-water pipe is connected to a second end of the housing. The outlet pipe is connected to a side of the housing. The membrane assembly is composed of multiple tubular membranes fitted within the housing, each tubular membrane defining a central passage therein, each tubular membrane defining multiple pores through a cylindrical wall surrounding the central passage, such that water fed from the inlet pipe can be filtered out of the membrane assembly to flow into the outlet pipe for a further treatment or a use point, or can be used to wash away impurities left in the membrane assembly and then be directed to the dirty-water pipe for a utilization.

### TECHNICAL FIELD OF THE INVENTION

The present invention relates to a structure for filtering water and, more particularly, to a structure that can service for a long period of time without a need to replace the filtering medium thereof, and can reuse the water of having been used to wash away the impurities left in the filtering medium.

### DESCRIPTION OF THE PRIOR ART

As shown in FIG. 1, a conventional water filter comprises an inlet pipe 2, an outlet pipe 4, a housing 6, and a filter medium 8, in which the inlet pipe 2 is connected with a bottom end of the housing 6, the outlet pipe 4 is connected with a top end of the housing 6, and the filter medium 8 is filled within the housing 6.

Water can be pressurized to flow through the filter medium 8 to obtain more pure water, leaving some impurities, such as sediments, algae or large bacteria behind.

However, after a long time of use, the filtering medium 8 will be clogged with a significant amount of impurities and easily to lead the growth of bacteria. Thus, the filtering medium 8 should be replaced.

In view of the drawbacks of the conventional filters, based on the long-term experiences in developing the related products of water filters. The applicant has contrived an improved structure for filtering water, whereby the impurities collected in the filtering medium can be washed away without replacing the medium, and the washed water can be reused.

### SUMMARY OF THE INVENTION

The primary object of the present invention is to provide a structure for filtering water, whereby the structure can service for a long period of time without a need to replace the filtering medium thereof, and the water of having been used to wash away the impurities left in the filtering medium can be reused.

The structure for filtering water comprises a housing, an inlet pipe, a dirty-water pipe, an outlet pipe, and a membrane assembly. The inlet pipe is connected to a first end of the housing. The dirty-water pipe is connected to a second end of the housing, opposite to the first end. The outlet pipe is connected to a side of the housing between the first end and the second end of the housing. The membrane assembly is composed of a plurality of tubular membranes fitted in parallel within the housing between the first end and the second end of the housing, each tubular membrane defining a central passage therein to allow the inlet pipe to communicate with the dirty-water pipe, each tubular membrane defining a plurality of pores through a cylindrical wall surrounding the central passage, each pore having a size sufficient for water to pass through the wall to the side of the housing but insufficient for impurities contained in water to pass through the wall, such that water fed from the inlet pipe can be filtered out of the membrane assembly to flow into the outlet pipe for a further treatment or a use point, or can be used to wash away impurities left in the membrane assembly and then be directed to the dirty-water pipe for a utilization.

Other objects, advantages, and novel features of the present invention will become more apparent from the following detailed description when taken in conjunction with the accompanying drawings.

### BRIEF DESCRIPTION OF THE DRAWINGS

FIG. 1 is a sectional view, which schematically shows a conventional water filter.

FIG. 2 is a sectional view, which schematically shows a structure for filtering water according to the present invention.

FIG. 2A is an enlarged view of a portion of FIG. 2.

FIG. 3 is an enlarged sectional view, which schematically shows the structure for filtering water according to the present invention.

FIG. 3A is an enlarged view of a portion of FIG. 3.

FIG. 4 is a schematic view, which shows an operation of the structure for filtering water according to the present invention.

FIG. 5 is an enlarged sectional view, which schematically shows a filtering operation of the structure for filtering water according to the present invention.

FIG. 6 is an enlarged sectional view, which schematically shows a washing operation of the structure for filtering water according to the present invention.

FIG. 7 is a plan view showing an exemplary application of the present invention.

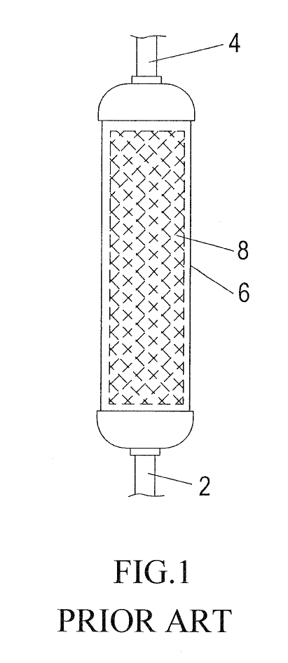

### DETAILED DESCRIPTION OF THE PREFERRED EMBODIMENTS

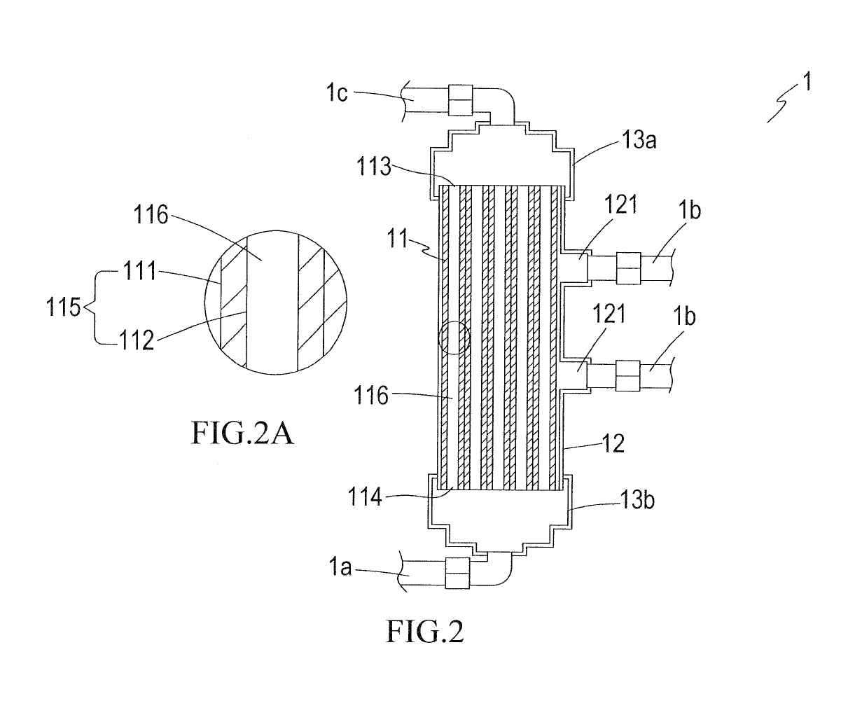

FIGS. 2 and 2A schematically shows a sectional view of a structure for filtering water, indicated at numeral 1, according to the present invention. The structure generally comprises a housing 12, an inlet pipe 1a, two outlet pipes 1b, a dirty-water pipe 1c, and a membrane assembly 11. The housing 12 is formed as a hollow cylindrical body, which is provided with a first head 13b at a first end (or bottom end) thereof and a second head 13a at a second end (or top end) thereof, opposite to the first end. The inlet pipe 1a is connected to the first end of the housing 12 via the first head 13b. The dirty-water pipe 1c is connected to the second end of the housing 12 via the second head 13a. The two outlet pipes 1b are connected to a side of the housing 12 between the first end and the second end of the housing 12 respectively via two outlets 121 of the housing 12. The membrane assembly 11 is composed of a plurality of tubular membranes fitted in parallel within the housing 12 between the first end and the second end of the housing 12. Each tubular membrane defines a central passage 116 therein to allow the inlet pipe 1a to communicate with the dirty-water pipe 1c. Each tubular membrane defines a plurality of pores (not shown) through a cylindrical wall surrounding the central passage 116, each pore having a size sufficient for water to pass through the wall to the side of the housing 12 but insufficient for impurities, such as particles, sediments, algae or large bacteria, contained in water to pass through the wall. Preferably, each pore has a size approximately from 0.01 μm to 0.1 μm. As shown in FIG. 2, water in the central passage 116 can be filtered through the cylindrical wall shown between numeral 111 and numeral 112. In such arrangement, the water fed from the inlet pipe 1a can be filtered out of the membrane assembly 11 to flow into the outlet pipes 1b to be directed to a further treatment or a use point.

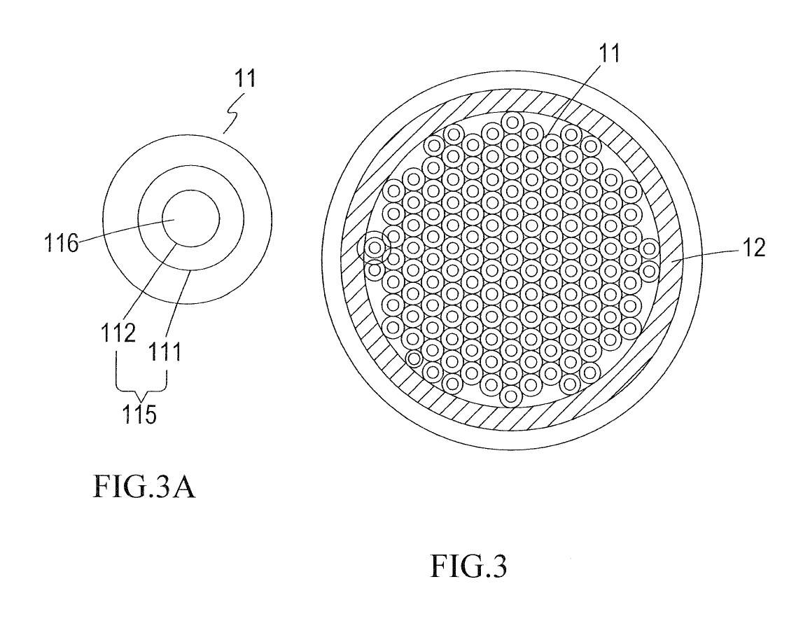

FIGS. 3 and 3A schematically shows a sectional view of the structure for filtering water of the present invention, in which the housing 12 is full of the tubular membranes of the membrane assembly 11.

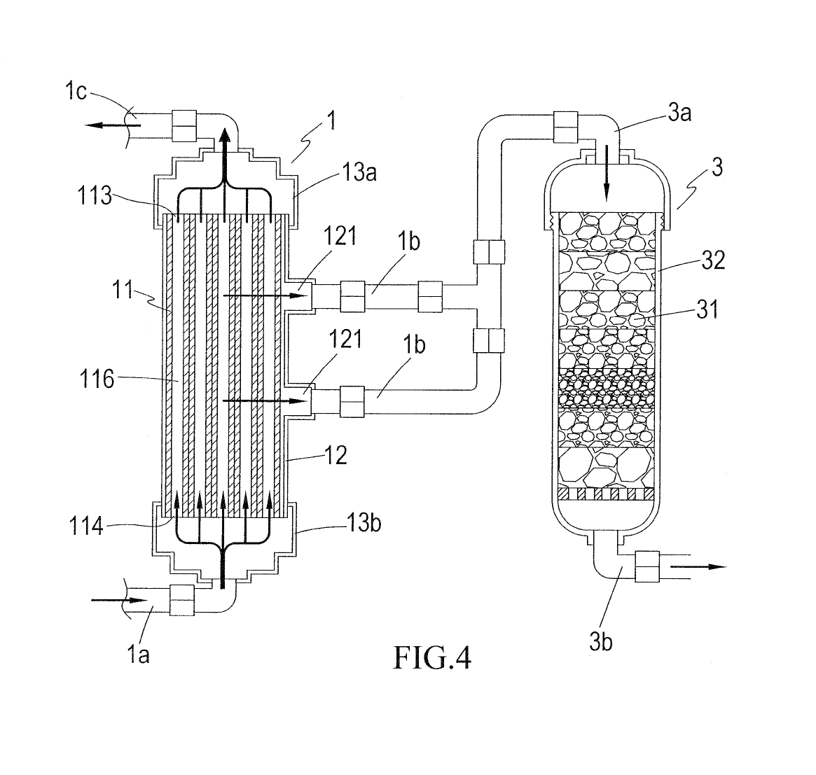

In operation, as shown in FIG. 4, when an inlet control valve (not shown) is opened, water can flow into the first head 13b via the inlet pipe 1a and then flow into membrane assembly 11 within the housing 12 via entries 114 of the tubular membranes. The water in the central passage 116 of each tubular membrane can be filtered out of the wall of each membrane to flow to the side of the housing 12 to flow into the outlet pipes 1b. When a dirty-water control valve (not shown) is opened, the water fed from the inlet pipe 1a can flow into the membrane assembly 11 and wash away the impurities left on the interior surface of each tubular membrane, via exits 113 of the tubular membranes, to flow into the dirty-water pipe 1c to be further utilized.

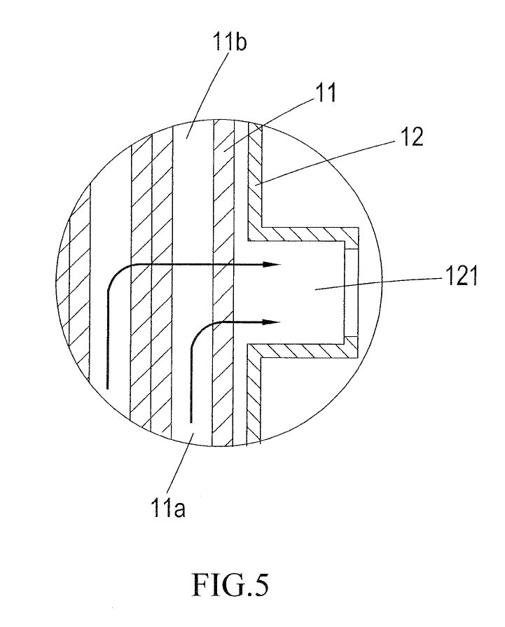

FIG. 5 schematically shows a filtering operation of the structure, in which water flows from the central passage 116 of each tubular membrane to the outlet pipe 1b through the wall of each membrane.

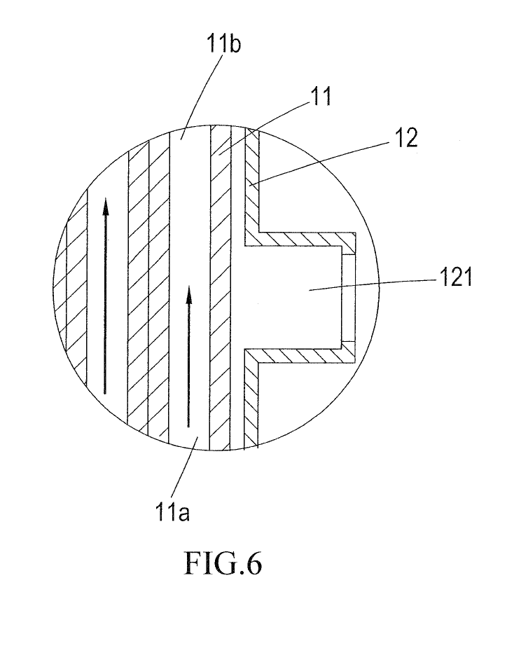

FIG. 6 schematically shows a washing operation of the structure, in which water flows from the inlet pipe 11a to the dirty-water pipe 11c and washes away the impurities, such as such as particles, sediments, algae or large bacteria, left on the wall of each tubular membrane to the dirty-water pipe 11c to be further utilized, so as to achieve the purpose of cleaning the filtering medium.

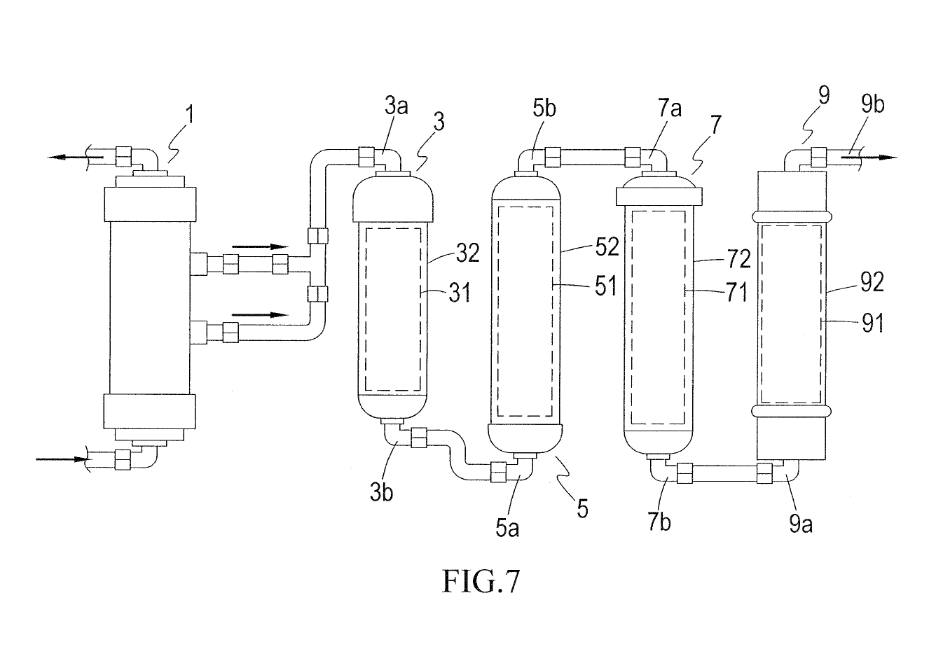

FIG. 7 schematically shows an exemplary application of the structure for filtering water according to the present application, which includes 5 stages of filtration. As shown, the first stage of filtration relates to a membrane filter 1, as described in the above. The second stage of filtration relates to a ceramics filter 3, as will be described in the following. The third stage of filtration relates to a far-infrared filter 5, as will be described in the following. The fourth stage of filtration relates to a first activated-carbon filter 7, as will be described in the following. The fifth stage of filtration relates to a second activated-carbon filter, as will be described in the following.

In this application, when an inlet control valve (not shown) is opened, water can be fed from the inlet pipe of the membrane filter 1 to flow through the membrane assembly to enter the outlet pipe of the membrane filter 1 to be directed to a next stage of filtration.

The ceramics filter 3 includes a housing 32 filled with a plurality ceramics particles 31, an inlet pipe 3a connected with the outlet pipes of the membrane filter 1, and an outlet pipe 3b. In this stage, the ceramics are stacked in layers like the stratum structure. The trace elements and negative ions beneficial to human body can be carried with water.

The far-infrared filter 5 includes a housing 52 filled with a plurality far-infrared particles 51, an inlet pipe 5a connected with the outlet pipe 3b of the ceramics filter 3, and an outlet pipe 5b. The far-infrared particles can energize water, converting it into smaller molecular clusters to be easily absorbed by body cells.

The first activated-carbon filter 7 includes a housing 72 filled with a plurality activated-carbon particles 71 of large size, an inlet pipe 7a connected with the outlet pipe 5b of the far-infrared filter, and an outlet pipe 7b. This stage can reduce odors, chlorine, and many organic contaminants in water.

The second activated-carbon filter 9 includes a housing 92 filled with a plurality activated-carbon particles 91 of small size, an inlet pipe 9a connected with the outlet pipe 7b of the first activated-carbon filter 7, and an outlet pipe 9b to be directed to a use point. This stage can further reduce odors, chlorine, and many organic contaminants in water.

In view of the foregoing, the present invention can service for a long period of time without a need to replace the filtering medium thereof, and can reuse the water of having been used to wash away the impurities left in the filtering medium. It is believed that the present invention is an innovative creation with useful functions.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A structure for filtering water, comprising:
a membrane filter including a housing, an inlet pipe connected to a first end of said housing, a dirty-water pipe connected to a second end of said housing opposite to said first end of said housing, an outlet pipe connected to a side of said housing between said first end and said second end of said housing, and a membrane assembly composed of a plurality of tubular membranes fitted in parallel within said housing between said first end and said second end of said housing, each tubular membrane defining a central passage therein to allow said inlet pipe to communicate with said dirty-water pipe, each tubular membrane defining a plurality of pores through a cylindrical wall surrounding said central passage, each pore having a size sufficient for water to pass through the wall to the side of said housing but insufficient for impurities contained in water to pass through the wall, such that water fed from said inlet pipe can be filtered out of said membrane assembly to flow into said outlet pipe, or can be used to wash away impurities left in said membrane assembly and then be directed to said dirty-water pipe for a utilization;
a ceramics filter including a housing filled with a plurality of ceramics particles, an inlet pipe connected with said outlet pipe of said membrane filter, and an outlet pipe;
a far-infrared filter including a housing filled with a plurality of far-infrared particles, an inlet pipe connected with said outlet pipe of said ceramics filter, and an outlet pipe; and
an activated-carbon filter including a housing filled with a plurality of activated-carbon particles, an inlet pipe connected with said outlet pipe of said far-infrared filter, and an outlet pipe directed to a use point.

2. A structure for filtering water as claimed in claim 1, wherein said housing is provided with a first head at said first end of said housing and a second head at said second end of said housing, said inlet pipe is connected with said housing via said first head, said dirty-water pipe is connected with said housing via said second head, said membrane assembly is fitted between said first head and said second head.

3. A structure for filtering water as claimed in claim 2, wherein said ceramics particles in said ceramics filter are sintered into particles of different sizes, which are stacked in layers within said housing of said ceramics filter.

4. A structure for filtering water as claimed in claim 1, wherein said pores of said tubular membranes each has a size approximately from 0.01 μm to 0.1 μm.
